(19) United States
(12) Patent Application Publication
(10) Pub. No.: US 2004/0162069 A1
(43) Pub. Date: Aug. 19, 2004

(54) Apparatus and method for fast call setup in a mobile communication system

(75) Inventors: Dae-Gyun Kim, Seongnam-si (KR); Hyeon-Woo Lee, Suwon-si (KR); Beom-Sik Bae, Suwon-si (KR); Kyong-Joan Chun, Seoul (KR); Jung-Soo Jung, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/777,432

(22) Filed: Feb. 12, 2004

(30) Foreign Application Priority Data
Feb. 13, 2003 (KR) 9146-2003

(51) Int. Cl. H04Q 7/20

(52) U.S. Cl. 455/434; 455/450; 455/509

(57) ABSTRACT

Disclosed is a method for performing call setup in a mobile communication system having a base station for serving a mobile station, and a mobile switching center for controlling the base station. At the onset of entry of a recipient's phone number, the mobile station transmits an origination message to the base station, and the base station responds to the origination message from the mobile station, and assigns wireless channels to the mobile station. The mobile station transmits to the base station an origination continuation message, if assignment of the wireless channels is completed and receiving of the recipient's phone number is completed. Upon receiving the origination continuation message, the base station requests the mobile switching center to perform call setup in a wired section.

### PRIORITY

This application claims priority under 35 U.S.C. § 119 to an application entitled “Apparatus and Method for Fast Call Setup in a Mobile Communication System” filed in the Korean Intellectual Property Office on Feb. 13, 2003 and assigned Serial No. 2003-9146, the contents of which are incorporated herein by reference.

### BACKGROUND OF THE INVENTION

1. Field of the Invention

The present invention relates generally to call setup in a mobile communication system, and in particular, to an apparatus and method for more rapidly performing call setup.

2. Description of the Related Art

FIG. 1 is a diagram illustrating a configuration of a typical cellular mobile communication system. As illustrated in FIG. 1, a cellular mobile communication system includes a plurality of small service areas called “cells” defined by dividing its entire service area into a plurality of areas each of which is covered by one of base stations (BSs) 20, 21 and 22. In the cellular mobile communication system, the base stations 20, 21 and 22 are controlled by a mobile switching center (MSC) 10 on a centralized basis so that users can continue a call even while moving between cells. A user sets up a call thorough the cellular mobile communication system using a mobile station (MS) 30 capable of wirelessly communicating with the base stations 20, 21 and 22, to perform a voice call or data communication with another mobile station. A procedure for setting up an outgoing call in a cellular mobile communication system will now be described.

FIG. 2 is a message flow diagram illustrating a procedure for setting up an outgoing call according to the prior art. Referring to FIG. 2, in step (a), a mobile station transmits to a base station an Origination message containing a phone number of a desired recipient (or called party). Then the base station responds thereto by sending to the MS a base station acknowledgement order (BS Ack Order) in step (b), and sends to a mobile switching center a Configuration Module (CM) Service Request message in step (c). Upon receiving the CM Service Request message, the mobile switching center assigns resources for the mobile station that transmitted the Origination message, and sends to the base station in step (d) an Assignment Request message in order to request resource assignment in a wireless section (or wireless link).

In response to the Assignment Request message, the base station assigns a traffic channel over which it will communicate with the mobile station, and transmits to the mobile station in step (e) a Channel Assignment message. Upon receiving the Channel Assignment message, the mobile station sets up a traffic channel according to the received Channel Assignment message. After setting up a traffic channel, the mobile station transmits to the base station in step (f) a preamble (Tch Preamble) over the assigned traffic channel. When the preamble is successfully received, the base station transmits to the mobile station a BS Ack Order in step (g). In answer to the BS Ack Order, the mobile station transmits to the base station a mobile station acknowledgement order (MS Ack Order) in step (h).

After exchange of the Ack Orders, the mobile station exchanges with the base station a Service Connect message and a Service Connect Completion message in steps (i) and (j), for service negotiation. When the service negotiation is completed, the base station sends to the mobile switching center an Assignment Complete message in step (k), completing a call setup procedure requested by a calling party. Then the mobile switching center transmits to the mobile station in step (l) a ring back tone (RBT) via the base station until a response from a called party is received.

In such a conventional call setup procedure, commonly, 5 seconds are required for the mobile switching center to complete the resource assignment after receiving a CM Service Request message from the base station, and thereafter, 5 additional seconds are required for assignment of the wireless resources to the mobile station by the base station. The time delay caused by such a call setup procedure inconveniences users.

### SUMMARY OF THE INVENTION

It is, therefore, an object of the present invention to provide a method for immediately performing resource assignment by a base station upon start of dial input and performing resource assignment by a mobile switching center after completion of the dial input in a call setup procedure.

It is another object of the present invention to provide a method for simultaneously performing resource assignment by a mobile switching center and resource assignment by a base station in a call setup procedure.

It is further another object of the present invention to provide a method for simultaneously performing resource assignment by a mobile switching center and immediate resource assignment by a base station upon start of dial input.

In accordance with one aspect of the present invention, there is provided a method for performing call setup in a mobile communication system including a base station for serving a mobile station in a service area thereof, and a mobile switching center for controlling the base station. The method comprising the steps of: upon receiving a recipient's phone number, transmitting by the mobile station an origination message to the base station; responding, by the base station, to the origination message from the mobile station, and setting up wireless channels to the mobile station; transmitting, by the mobile station, an origination continuation message to the base station, if setup of the wireless channels is completed and receiving of the recipient's phone number is completed; and upon receiving the origination continuation message, requesting by the base station the mobile switching center to perform call setup in a wired section.

In accordance with another aspect of the present invention, there is provided a method for performing call setup in a mobile communication system including a base station for serving a mobile station in a service area thereof, and a mobile switching center for controlling the base station. The method comprising the steps of: transmitting, by the mobile station, an origination message to the base station, if an outgoing call is needed; and upon receiving the origination message, transmitting by the base station a service request message for the mobile station to the mobile switching center, setting up wireless channels to the mobile station and performing service negotiation with the mobile station.

In accordance with further another aspect of the present invention, there is provided a method for performing call setup in a mobile communication system including a base station for serving a mobile station in a service area thereof, and a mobile switching center for controlling the base station. The method comprising the steps of: upon receiving a recipient's phone number, transmitting by the mobile station an origination message to the base station; upon receiving the origination message from the mobile station, transmitting by the base station a service request message to the mobile switching center and, at the same time, setting up wireless channels to the mobile station; upon completion of receiving the recipient's phone number, transmitting by the mobile station the recipient's phone number to the base station along with an origination continuation message; and upon receiving the origination continuation message, transmitting by the base station the recipient's phone number to the mobile switching center.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a typical cellular mobile communication system;

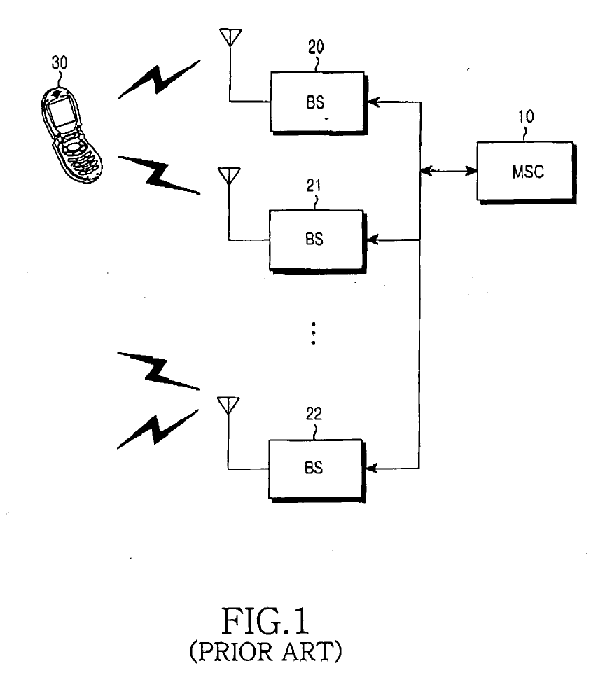

FIG. 2 is a message flow diagram illustrating a procedure for setting up an outgoing call according to the prior art;

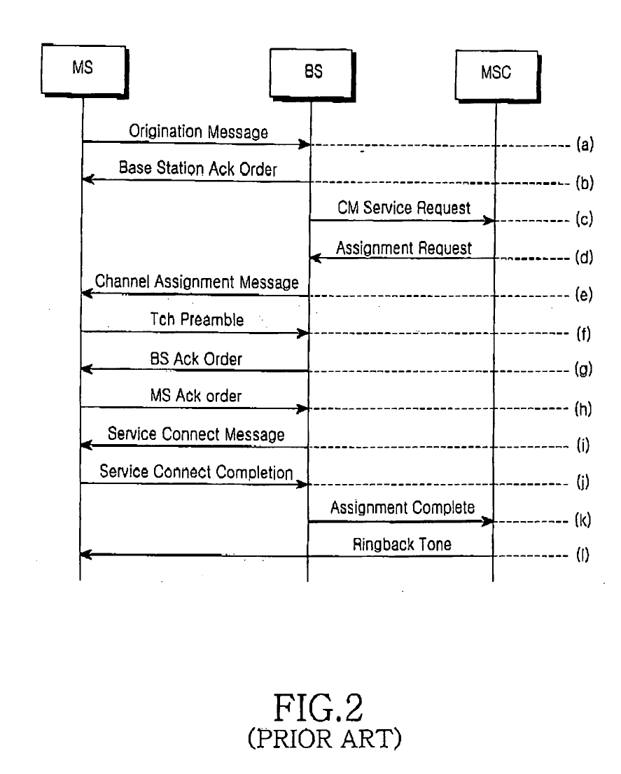

FIG. 3 is a message flow diagram illustrating a call setup procedure according to a first embodiment of the present invention;

FIG. 4 is a flowchart illustrating an operation of a mobile station according to a first embodiment of the present invention;

FIG. 5 is a flowchart illustrating an operation of a base station according to a first embodiment of the present invention;

FIG. 6 is a message flow diagram illustrating a call setup procedure according to a second embodiment of the present invention;

FIG. 7 is a flowchart illustrating an operation of a mobile station according to a second embodiment of the present invention;

FIG. 8 is a flowchart illustrating an operation of a base station according to a second embodiment of the present invention;

FIG. 9 is a message flow diagram illustrating a call setup procedure according to a third embodiment of the present invention;

FIG. 10 is a flowchart illustrating an operation of a mobile station according to a third embodiment of the present invention;

FIG. 11 is a flowchart illustrating an operation of a base station according to a third embodiment of the present invention; and

FIG. 12 is a block diagram illustrating a structure of a mobile station according to another embodiment of the present invention.

### DETAILED DESCRIPTION OF THE PREFERRED EMBODIMENT

Several preferred embodiments of the present invention will now be described in detail with reference to the annexed drawings. In the following description, a detailed description of known functions and configurations incorporated herein has been omitted for conciseness.

The present invention provides an apparatus and method for setting up a transmission channel during the dialing procedure in a mobile communication system. The apparatus and method proposed herein allocates a transmission channel from a base station (BS) to a mobile switching center (MSC) immediately after completion of the dialing procedure.

First Embodiment

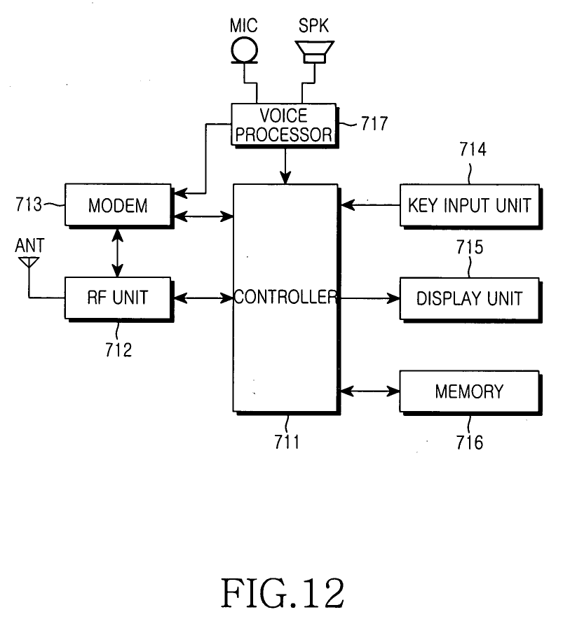

A first embodiment of the present invention performs call setup by a base station at the time when a user begins to input a phone number of a recipient with whom he or she desires to talk, i.e., before dial input is completed, and performs call setup by a mobile switching center the input of the phone number of the recipient is completed. An operation according to the first embodiment of the present invention will be described without consideration of speed dialing (or abbreviated dialing), which will be described with reference to FIG. 12.

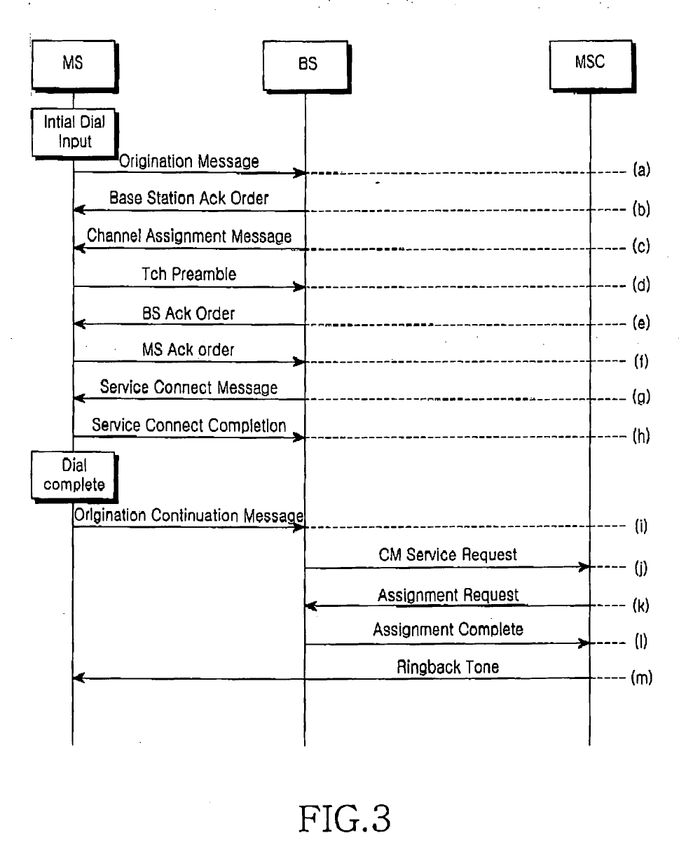

FIG. 3 is a message flow diagram illustrating a call setup procedure according to a first embodiment of the present invention. Referring to FIG. 3, when a user begins to input a phone number of a desired recipient, the mobile station transmits to a base station an Origination message in step (a). The Origination message transmitted at this step does not include a phone number of the recipient, but can include a dummy phone number comprised of ‘0s’. Then the base station responds thereto by sending to the mobile station a base station acknowledgement order (BS Ack Order) in step (b), and assigns a forward traffic channel and a corresponding reverse traffic channel without a wireless resource assignment request from a mobile switching center. The base station is designed such that it can perform an operation according to an embodiment of the present invention when it receives an Origination message not including a phone number of a recipient or including a dummy phone number consisting of ‘0s’. However, the base station can be designed such that it can perform the operation according to this embodiment of the present invention even when it receives an existing Origination message. In step (c), the base station immediately transmits to the mobile station a Channel Assignment message containing information on the assigned traffic channels. The base station has not yet sent a Configuration Module (CM) Service Request message to the mobile switching center.

Upon receiving the Channel Assignment message, the mobile station sets up a forward traffic channel and an associated reverse traffic channel according to the received Channel Assignment message. Thereafter, the mobile station transmits to the base station in step (d) a preamble (Tch Preamble) over the reverse traffic channel assigned by the base station. When the preamble is successfully received, the base station transmits to the mobile station a BS Ack Order in step (e), and in response, the mobile station transmits to the base station a mobile station acknowledgement order (MS Ack Order) in step (f). After completing setup of traffic channels in a wireless section (or wireless link) through exchange of the Ack Orders, the mobile station and the base station exchange a Service Connect message and a Service Connect Completion message in steps (g) and (h), thereby performing service negotiation for the traffic channels.

The call setup in a wireless section up to the service negotiation is generally completed before the user fully inputs a phone number of the recipient. Thereafter, when the user presses a Send button after completing input (or dialing) of the phone number of the recipient, the mobile station immediately transmits to the base station an Origination Continuation message containing the input recipient's phone number in step (i). Then the base station transmits to the mobile switching center a CM Service Request message in step (j).

If the call setup in a wireless section has not completed at the point when the Origination Continuation message is received, the base station transmits to the mobile switching center the CM Service Request message after completing the call setup in a wireless section.

The mobile switching center assigns wired resources in response to the CM Service Request message, and then transmits to the base station in step (k) an Assignment Request message to request assignment of a wireless resource. However, in the embodiment of the present invention, the base station has already assigned wireless resources to the mobile station. Therefore, the base station can regard the Assignment Request message as a message indicting that resource assignment by the mobile switching center is completed. Then, in step (l), the base station immediately transmits to the mobile switching center an Assignment Complete message in response to the Assignment Request message, completing the call setup procedure with the calling party. In step (m), the mobile switching center transmits to the mobile station a ring back tone (RBT) via the base station until a response from a called party is received.

According to the first embodiment of the present invention, a mobile station performs the call setup operation in a wireless section when a user inputs an initial button before pushing a Send button of the mobile station, or when the user desires to perform dialing while satisfying a predetermined condition. Upon receiving an Assignment Request message from a mobile switching center, a base station immediately transmits a response thereto, contributing to fast call setup. Such an operation can be equally performed even when speed dialing is performed. Even in a speed dialing mode, if a numeric key is input, the mobile station sends an Origination message, and the base station performs an operation equal to the operation described above. In addition, even in the speed dialing mode, the mobile station can transmit an Origination Continuation message containing a phone number in the same method as performed when the Send button is input. Specifically, if the last digit out of two or three-digit speed dial number is pressed for speed dialing, the mobile station reads a corresponding phone number from its memory. The mobile station can generate an Origination Continuation message using the read phone number as a recipient's phone number, and transmit to the base station the generated Origination Continuation message. In this way, the mobile station can immediately send an Origination message without waiting until the speed dial number is fully input. This will also be applied to other embodiments of the present invention.

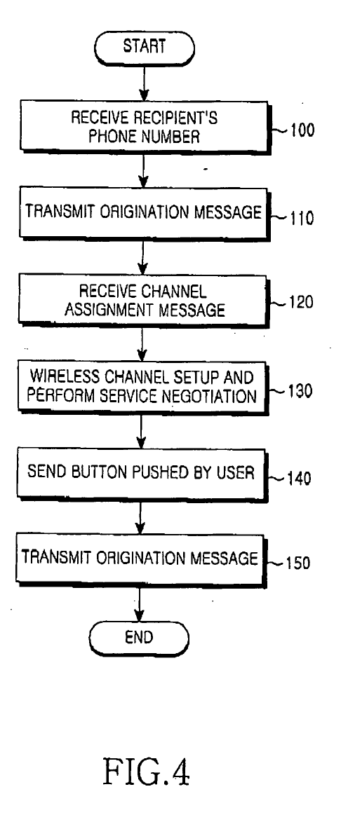

FIG. 4 is a flowchart illustrating an operation of a mobile station according to the first embodiment of the present invention. Referring to FIG. 4, if a recipient's phone number is input by a user in step 100, a mobile station immediately transmits to a base station an Origination message not including the recipient's phone number in step 110. As described in connection with FIG. 3, the mobile station can generate a dummy phone number consisting of ‘0s’ and transmit the generated dummy phone number along with the Origination message. If a Channel Assignment message is received from the base station in response to the Origination message in step 120, the mobile station performs channel setup in a wireless section and service negotiation in step 130. That is, the mobile station sets up a channel in order to perform communication over a traffic channel previously assigned by the base station. Further, the mobile station transmits to the base station a preamble over a traffic channel set up by the base station. Thereafter, if a BS Ack Order is received from the base station, the mobile station performs service negotiation with the base station. After the service negotiation is completed, if the user has fully input the recipient's phone number and pushes a Send button in step 140, the mobile station transmits to the base station an Origination Continuation message containing the recipient's phone number in step 150.

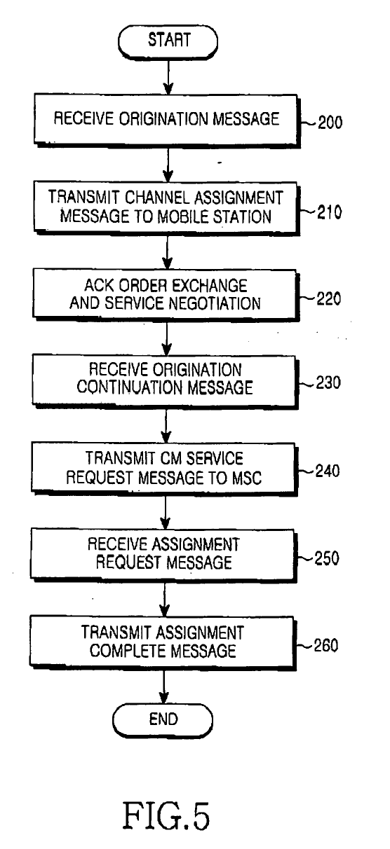

FIG. 5 is a flowchart illustrating an operation of a base station according to the first embodiment of the present invention. Referring to FIG. 5, in step 200, a base station receives from a mobile station an Origination message not including a recipient's phone number or including a dummy phone number consisting of ‘0s’. Then the base station assigns wireless resources for the mobile station, i.e., forward and reverse traffic channels, without sending to a mobile switching center, a CM Service Request message and transmits to the mobile station in step 210 a Channel Assignment message including assignment information of the forward and reverse traffic channels. In step 220, the base station performs Ack Order exchange and service negotiation. That is, the base station receives a preamble from the mobile station, and transmits to the mobile station a BS Ack Order in response to the preamble. Thereafter, the base station receives from the mobile station an MS Ack Order, and performs service negotiation. Thereafter, if an Origination Continuation message containing a recipient's phone number is received from the mobile station in step 230, the base station transmits to the mobile switching center in step 240 a CM Service Request message to perform call setup in a wired section (or wired link). Thereafter, if an Assignment Request message is received from the mobile switching center in step 250, the base station immediately transmits an Assignment Complete message to the mobile switching center in step 260.

Second Embodiment

A second embodiment of the present invention performs call setup in a wireless section while an Origination message is received from a mobile station and call setup in a wired section is performed. An operation of the second embodiment can be performed when speed dialing is performed, or performed in a mobile station not supporting the first and third embodiments of the present invention.

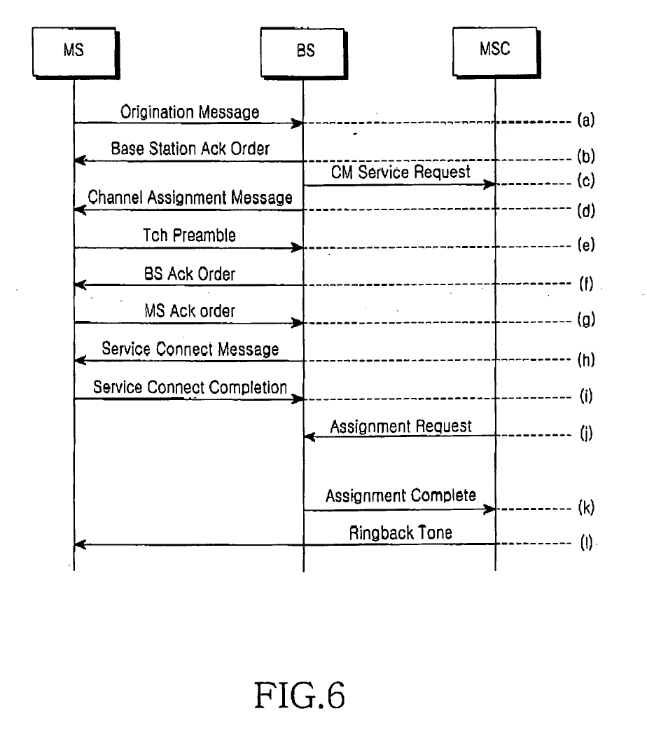

FIG. 6 is a message flow diagram illustrating a call setup procedure according to a second embodiment of the present invention. Referring to FIG. 6, a mobile station transmits to a base station in step (a) an Origination Message containing a recipient's phone number. Then the base station sends to the mobile station in step (b) a BS Ack Order in response to the Origination message, and transmits to a mobile switching center in step (c) a CM Service Request message to request the mobile switching center to assign a wired resource. Thereafter, the base station immediately assigns resources in a wireless section, i.e., a forward traffic channel and its associated reverse traffic channel, without receiving an Assignment Request message from the mobile switching center. Thereafter, the base station transmits to the mobile station in step (d) a Channel Assignment message containing the assignment information. In this manner, resource assignment for wired section by the mobile switching center and resource assignment for wireless section by the base station are simultaneously performed.

Upon receiving the Channel Assignment message, the mobile station sets up a forward traffic channel and its associated reverse traffic channel according to the received Channel Assignment message. In step (e), the mobile station transmits to the mobile station a preamble (Tch Preamble) over the reverse traffic channel assigned by the base station. Upon receiving the preamble from the mobile station, the base station transmits to the mobile station a BS Ack Order in step (f), and in response, the mobile station transmits to the base station an MS Ack Order in step (g).

After completing setup of wireless traffic channels through exchange of the Ack Orders, the mobile station and the base station exchange a Service Connect message and a Service Connect Completion message in steps (h) and (i), thereby performing service negotiation. After the call setup in a wireless section up to the service negotiation is completed, the mobile switching center transmits to the base station an Assignment Request message in step (j). At this point, because the base station has already assigned or is assigning channels to the mobile station, it regards the Assignment Request message received from the mobile switching center as a message indicting that call setup in a wired section is completed. Therefore, the base station immediately transmits to the mobile switching center an Assignment Complete message in step (k), completing the call setup of the calling party. Unlike that shown in FIG. 6, the Assignment Request message can also be transmitted before the call setup in a wireless section is completed. After completing the call setup in a wireless section, the base station transmits to the mobile switching center an Assignment Complete message. After the Assignment Complete message is received at the mobile switching center, i.e., if call setup at a calling party is completed, the mobile switching center transmits to the mobile station a ring back tone via the base station in step (l).

In the second embodiment of the present invention, call setup in a wireless section and call setup in a wired section are simultaneously performed, minimizing a time delay during the call setup procedure.

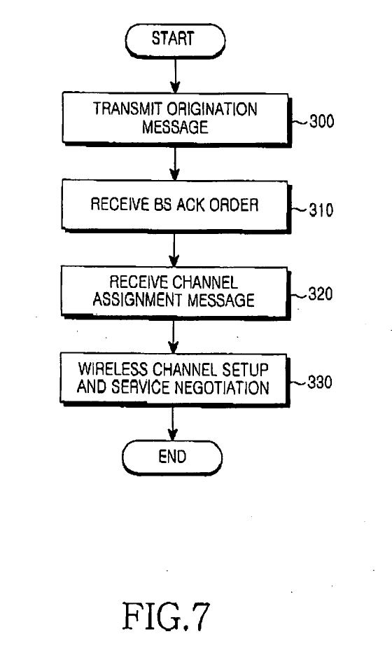

FIG. 7 is a flowchart illustrating an operation of a mobile station according to a second embodiment of the present invention. Referring to FIG. 7, a mobile station transmits to a base station an Origination message containing a phone number of a desired recipient in step 300, and receives a BS Ack Order from the base station in step 310. Thereafter, the mobile station receives from the base station a Channel Assignment message containing assignment information of wireless channels in step 320, and performs wireless channel setup and service negotiation according to the assignment information in step 330. That is, the mobile station sets up a forward traffic channel and its associated reverse traffic channel. Thereafter, the mobile station transmits to the base station a preamble over the reverse traffic channel assigned by the base station, exchanges Ack Orders with the base station, and performs service negotiation.

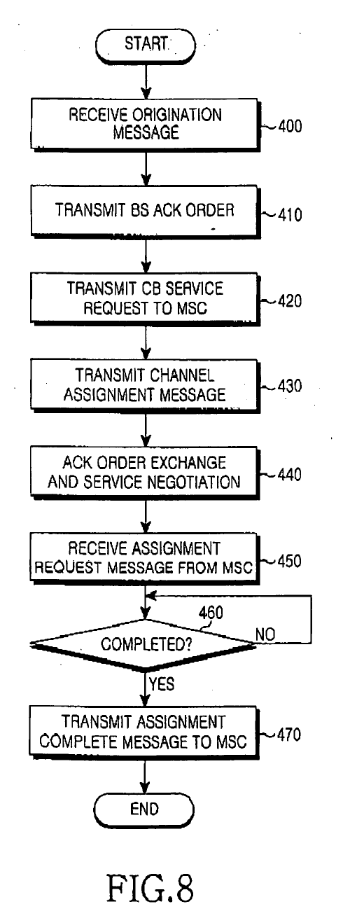

FIG. 8 is a flowchart illustrating an operation of a base station according to the second embodiment of the present invention. Referring to FIG. 8, a base station receives from a mobile station an Origination message containing a recipient's phone number in step 400, and transmits to the mobile station a BS Ack Order in step 410. Thereafter, in step 420, the base station transmits to a mobile switching center a CM Service Request message. Thereafter, the base station immediately assigns wireless resources, i.e., a forward traffic channel and its associated reverse traffic channel, without receiving from the mobile switching center, an Assignment Request message and then transmits to the mobile station in step 430 a Channel Assignment message containing the assignment information.

In step 440, the base station performs Ack Order exchange and service negotiation in step 440. That is, the base station receives a preamble from the mobile station over the assigned reverse traffic channel. Thereafter, the base station exchanges Ack Orders with the mobile station, and performs service negotiation. If an Assignment Request message is received from the mobile switching center in step 450, the base station determines in step 460 whether setup of wireless channels is completed. If it is determined that setup of wireless channels is completed, the base station transmits to the mobile switching center an Assignment Complete message in step 470. However, if it is determined in step 460 that setup of wireless channels is not completed, the base station waits until setup of the wireless channels is completed before transmitting to the mobile switching center the Assignment Complete message.

Third Embodiment

In a third embodiment of the present invention, a base station and a mobile switching center simultaneously perform call setup at the time when a user begins to input a phone number of a desired recipient with whom he or she desires to talk. Like the first embodiment, the third embodiment will also be described without consideration of speed dialing, which will be described with reference to FIG. 12.

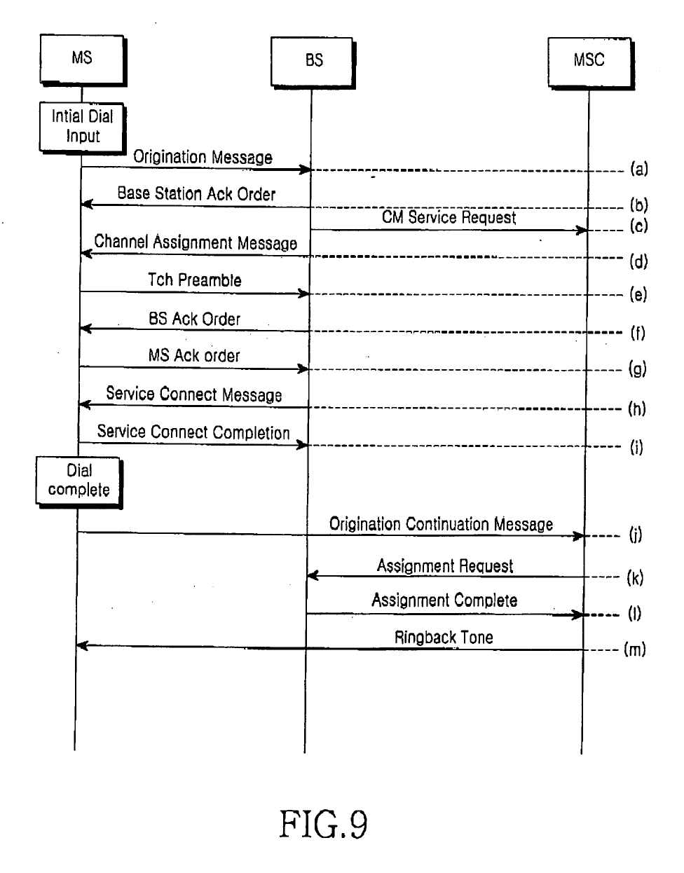

FIG. 9 is a message flow diagram illustrating a call setup procedure according to the third embodiment of the present invention. Referring to FIG. 9, when a user begins to dial a phone number of a desired recipient, the mobile station transmits an Origination message to a base station in step (a). In this case, the Origination message does not include a recipient's phone number, or includes a dummy phone number consisting of ‘0s’. Then the base station responds to the Origination message by sending to the mobile station a BS Ack Order in step (b), and transmits to a mobile switching center a CM Service Request message in step (c) in order to request the mobile switching center to perform necessary resource assignment in a wired section.

At the same time, the base station assigns a forward traffic channel and its associated reverse traffic channel without receiving from the mobile switching center an Assignment Request message for wireless resources, and transmits to the mobile station in step (d) a Channel Assignment message containing the assignment information. The mobile station assigns a forward traffic channel and its associated reverse traffic channel according to the assignment information included in the Channel Assignment message, and transmits to the base station a preamble (Tch Preamble) over the assigned reverse traffic channel in step (e). Upon receiving the preamble, the base station transmits to the mobile station a BS Ack Order in step (f). In response to the BS Ack Order, the mobile station creates an MS Ack Order and transmits to the base station the MS Ack Order in step (g). After completing setup of traffic channels in a wireless section through exchange of the Ack Orders, the mobile station and the base station exchange a Service Connect message and a Service Connect Completion message in steps (h) and (i), thereby performing service negotiation.

Thereafter, if the user pushes a Send button after completing input (or dialing) of a recipient's phone number, the mobile station immediately transmits to the base station in step (j) an Origination Continuation message containing the recipient's phone number and the base station then transfers to the mobile switching center the recipient's phone number. Independently, the mobile switching center transmits to the base station an Assignment Request message in step (k), when it completes resource assignment in a wired section. Optionally, the Assignment Request message can be transmitted to the base station before the time shown in FIG. 9. That is, the mobile switching center can transmit to the base station the Assignment Request message as soon as the mobile switching center completes resource assignment in a wired section. Therefore, if call setup in a wireless section has been completed at the time when the Assignment Request message is received, the base station immediately transmits to the mobile switching center an Assignment Complete message in step (l). However, if call setup in a wireless section has not completed, the base station sends to the mobile switching center an Assignment Complete message after completing the call setup in a wireless section. In this embodiment, the base station has already performed assignment of wireless resources before the Assignment Request message is received. Therefore, since preparation for call setup in a wired section is completed, the Assignment Complete message can be used as a message indicating that a procedure for call setup for the calling party is completed. In addition, the Assignment Request message can be used as a message indicating completed assignment of wired resources.

In the third embodiment of the present invention, call setup in a wireless section and call setup in a wired section are simultaneously performed before input of recipient's phone number is completed, thereby contributing to fast call setup.

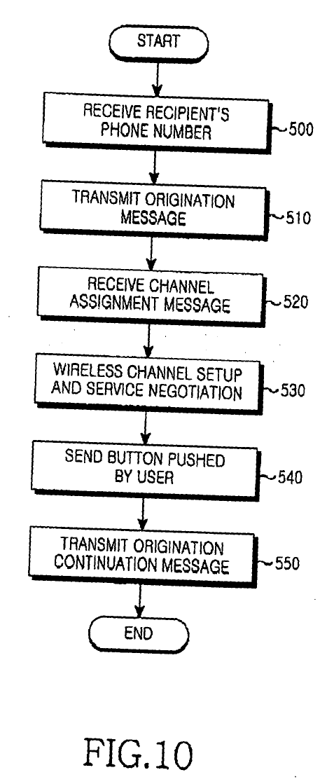

FIG. 10 is a flowchart illustrating an operation of a mobile station according to the third embodiment of the present invention. Referring to FIG. 10, if a user begins to input a recipient's phone number in step 500, a mobile station immediately transmits to a base station an Origination message not containing a recipient's phone number in step 510. The Origination message, as stated in connection with FIG. 9, can include a dummy phone number consisting of ‘0s’. If a Channel Assignment message is received from the base station in step 520, the mobile station performs channel setup in a wireless section and service negotiation in step 530. That is, the mobile station sets up a traffic channel according to the received Channel Assignment message, and transmits to the base station a preamble over the assigned traffic channel. Thereafter, the mobile station performs service negotiation upon receiving a BS Ack Order. If the user presses a Send button after completing input of a recipient's phone number in step 540, the mobile station transmits to the base station an Origination Continuation message containing the recipient's phone number in step 550.

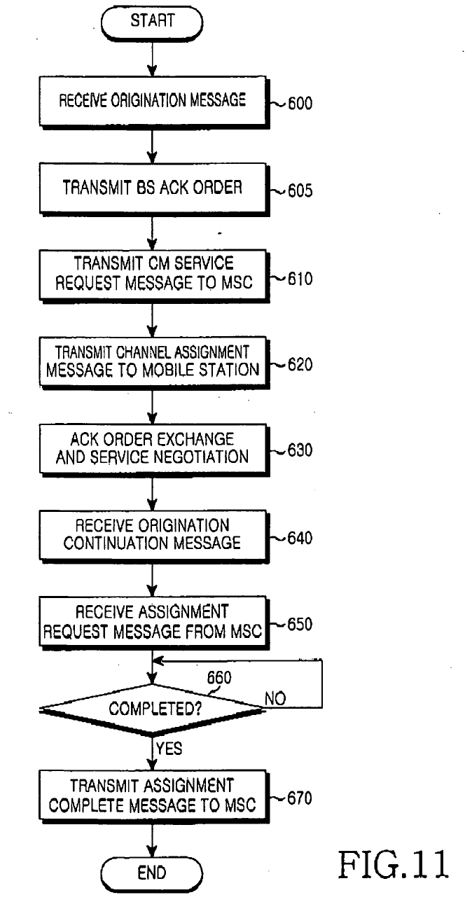

FIG. 11 is a flowchart illustrating an operation of a base station according to the third embodiment of the present invention. Referring to FIG. 11, if an Origination message that does not contain a recipient's phone number or an Origination message that contains a dummy phone number consisting of ‘0s’ is received from a mobile station in step 600, a base station generates a BS Ack Order message and transmits to the mobile station the BS Ack Order in step 605. In step 610, the base station transmits to a mobile switching center a CM Service Request message. Thereafter, in step 620, the base station assigns wireless resources, i.e., forward and reverse traffic channels, for the mobile station, and transmits to the mobile station a Channel Assignment message containing the assignment information. In step 630, the base station performs service negotiation after Ack Order exchange with the mobile station through the assigned wireless channels. Specifically, the base station transmits to the mobile station a BS Ack Order upon receiving from the mobile station, a preamble and then receives from the mobile station an MS Ack Order. After exchange of the Ack Orders, the base station performs service negotiation with the mobile station. In step 640, the base station receives from the mobile station an Origination Continuation message and transmits to the mobile switching center the received Origination Continuation message. Thereafter, if an Assignment Request message is received from the mobile switching center in step 650, the base station determines in step 660 whether call setup in a wireless section is completed. If the call setup in a wireless section is completed, the base station transmits to the mobile switching center an Assignment Complete message in step 670. Otherwise, the base station waits until the call setup in a wireless section is completed to transmit the Assignment Complete message.

FIG. 12 is a block diagram illustrating a structure of a mobile station according to an embodiment of the present invention. An operation of a mobile station according to an embodiment of the present invention will now be described in detail with reference to FIG. 12.

A radio frequency (RF) unit 712, under the control of a controller 711, sets up reverse and forward channels, down-converts a message or data received over a forward channel into a baseband signal, and provides the baseband signal to a modem 713. Further, the RF unit 712 up-converts data received from the modem 713 and transmits the up-converted data to a base station over a reverse channel. The modem 713 demodulates data received from the RF unit 712, and provides the demodulated data to the controller 711. Further, the modem 713 encodes and modulates a message or data received from the controller 711 and data received from a voice processor 717, and provides its output to the RF unit 712. Further, when the modem 713 receives a voice signal, the modem 713 converts the received voice signal into an electrical voice signal and outputs the electrical voice signal to a speaker. And, when the modem 713 receives an electrical voice signal from a microphone, the modem 713 modulates the received electrical voice signal and outputs the modulated signal to the RF unit 712. The voice processor 717 provides voice data to the modem 713 under the control of the controller 711. A key input unit 714 can be comprised of alphanumeric keys for dialing and function keys for setting various functions. Alternatively, the key input unit 714 can be comprised of a touch pad not having physical keys. The key input unit 714 generates a key signal corresponding to a key input by a user, and provides the key signal to the controller 711. A display unit 715 can be comprised of a part for providing a graphic user interface (GUI) to the user, and a part for providing an alarm to the user. The part for providing GUI can be generally comprised of a liquid crystal display (LCD), and the part for providing an alarm can be comprised of an alarm lamp or a light emitting diode (LED). A memory 716 stores a control program according to an embodiment of the present invention, and data generated during execution of the control program. In addition, the memory 716 stores phone numbers for speed dialing in association with their speed dial numbers. Further, a select bit for enabling or disabling an operation proposed in an embodiment of the present invention can be additionally provided. In this case, the select bit is also stored in the memory 716. An operation performed when such a select bit is used will now be described herein below.

It will be assumed that the mobile station operates based on one of the first to third embodiments of the present invention. The mobile station can be designed such that one of the operations based on the embodiments can be set during manufacturing process or selected at the discretion of a user. Herein, it will be assumed that one of the three embodiments is set during manufacturing of the mobile station. In this case, if the select bit is set, the mobile station performs a call setup procedure corresponding to one of the first to third embodiments of the present invention. Such a control operation of the controller 711 will now be described herein below.

When an initial key for dialing is input from the key input unit 714, the controller 711 generates an Origination message and outputs the Origination message to the modem 713. As stated above, the Origination message does not include a recipient's phone number, or includes a dummy phone number consisting of ‘0s’. If the controller 711 operates in a method proposed by the second embodiment, the controller 711 generates the Origination message after dialing is fully completed or when speed dialing is performed. In this case, the controller 711 does not perform the method of generating an Origination message not including recipient's phone number or including a dummy phone number. Even in the first and third embodiments, in a speed dialing mode, the controller 711 can generate an Origination message when a predetermined number of keys are input. For example, if the number of digits allocated for speed dialing is 2, i.e., if unique numbers of ‘00’ to ‘99’ are allocated for speed dialing, the controller 711 performs the first and third embodiments when a third digit is input. In addition, if the number of digits allocated for speed dialing is 3, i.e., if unique numbers of ‘000’ to ‘999’ are allocated for speed dialing, the controller 711 performs the first and third embodiments when a fourth digit is input. Alternatively, the controller 711 can operate as described in the last section of the first embodiment. Specifically, when the select bit is set, if an initial key for dialing is input, the controller 711 generates an Origination message and transmits the Origination message. Thereafter, if speed dialing is requested, the controller 711 reads a phone number corresponding to the input speed dial number from the memory 716, and generates an Origination message using the read phone number as a recipient's phone number. In this case, the controller 711 can generate an Origination message without determining whether a speed dial number is input.

When the Origination message not containing a called party's phone number or containing a dummy phone number is input to the modem 713, the modem 713 encodes and modulates the Origination message and outputs the modulated Origination message to the RF unit 712, under the control of the controller 711. Then the RF unit 712 up-converts the modulated Origination message and transmits the up-converted Origination message over a reverse link. Thereafter, a BS Ack Order message and a Channel Assignment message are received via the RF unit 712, processed by the modem 713, and then provided to the controller 711. Then the controller 711 performs a control operation of setting up forward and reverse traffic channels according to the Channel Assignment message. Specifically, the controller 711 controls the RF unit 712 so that it can receive traffic over the assigned forward traffic channel and transmit data over the assigned reverse traffic channel. Thereafter, the controller 711 transmits a preamble over the assigned reverse traffic channel. Subsequently, the controller 711 exchanges Ack Order messages with the base station, and performs service negotiation with the base station. Such an operation is equal to the conventional operation, so a detailed description thereof will not be given.

The controller 711 determines whether a dial complete signal is received from the key input unit 714. The “dial complete signal” can represent a signal generated when a Send key prepared in the key input unit 714 is pressed. However, in a speed dialing mode, the “dial complete signal” represents a signal generated when a speed dial number is input. For example, if the number of digits constituting a speed dial number is 2, the dial complete signal represents a signal generated when a second digit is pushed long. Alternatively, if the number of digits constituting a speed dial number is 3, the dial complete signal represents a signal generated when a third digit is depressed long. If such a Send signal is received, the controller 711 performs a control operation of generating an Origination Continuation message and transmitting the Origination Continuation message to the base station. In this control operation, the controller 711 generates an Origination Continuation message including an entire called party's phone number and provides the Origination Continuation message to the modem 713, the modem 713 performs encoding and modulation on the Origination Continuation message, and the RF unit 712 up-converts the modulated Origination Continuation message and transmits the up-converted Origination Continuation message to the base station. The following call setup operation is equal to the conventional one. The dial complete signal is not related to the second embodiment.

As can be appreciated from the foregoing description, the present invention immediately sets up wireless channels at the beginning of dial input in a call setup procedure in a mobile communication system. After completion of the dial input, a base station attempts call setup to a mobile switching center, or the base station and the mobile switching center simultaneously perform the call setup procedure. In this manner, it is possible to prevent a time delay caused by the call setup procedure, minimizing inconveniences to the user.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for performing call setup by a mobile station in a mobile communication system having a base station for serving the mobile station, and a mobile switching center for controlling the base station, the method comprising the steps of:
transmitting to the base station an origination message that does not contain a recipient's phone number;
upon receiving a channel assignment message from the base station, setting up wireless channels to the base station according to assignment information included in the channel assignment message; and
upon completion of entry of the recipient's phone number, transmitting to the base station an origination continuation message containing the recipient's phone number.

2. The method of claim 1, wherein the step of setting up wireless channels comprises the steps of:
assigning a forward traffic channel and a reverse traffic channel corresponding thereto according to the assignment information, and transmitting a preamble over the assigned reverse traffic channel; and
exchanging acknowledgement (Ack) orders with the base station and performing service negotiation with the base station.

3. The method of claim 1, wherein the origination message included a dummy phone number consisting of all ‘0s’.

4. A method for performing call setup by a base station upon a call attempt by a mobile station in a mobile communication system having the base station for serving the mobile station, and a mobile switching center for controlling the base station, the method comprising the steps of:
upon receiving an origination message that does not contain a recipient's phone number from the mobile station, assigning to the mobile station wireless resources and transmitting to the mobile station a channel assignment message containing the assignment information;
after transmitting the channel assignment message, assigning wireless channels to the mobile station;
after completion of the assignment of the wireless channels, transmitting to the mobile switching center a service request message if an origination continuation message containing a recipient's phone number is received from the mobile station; and
upon receiving an assignment request message from the mobile switching center, transmitting an assignment complete message to the mobile switching center.

5. The method of claim 4, further comprising the steps of:
upon receiving the assignment request message from the mobile switching center, determining whether assignment of the wireless channels is completed; and
transmitting the assignment complete message to the mobile switching center if assignment of the wireless channels is completed.

6. A method for performing call setup by a base station upon a call attempt by a mobile station in a mobile communication system having the base station for serving the mobile station, and a mobile switching center for controlling the base station, the method comprising the steps of:
upon receiving an origination message from the mobile station, transmitting to the mobile switching center a service request message, simultaneously assigning wireless resources to the mobile station, and transmitting a channel assignment message containing the assignment information to the mobile station;
assigning wireless channels to the mobile station; and
transmitting an assignment complete message to the mobile switching center if an assignment request message is received from the mobile switching center.

7. The method of claim 6, the assignment request message from the mobile switching center is received after a service request message is transmitted.

8. The method of claim 6, further comprising the steps of:
upon receiving the assignment request message from the mobile switching center, determining by the base station whether assignment of the wireless channels is completed; and
transmitting the assignment complete message to the mobile switching center if assignment of the wireless channels is completed.

9. A method for performing call setup by a base station upon call attempt by a mobile station in a mobile communication system having the base station for serving the mobile station, and a mobile switching center for controlling the base station, the method comprising the steps of:
upon receiving an origination message that does not contain a recipient's phone number from the mobile station, transmitting a service request message to the mobile switching center, simultaneously assigning wireless resources to the mobile station, and transmitting a channel assignment message including the assignment information to the mobile station;
after transmitting the channel assignment message, assigning wireless channels to the mobile station;
after assignment of the wireless channels, transmitting to the mobile switching center a recipient's phone number if an origination continuation message is received from the mobile station; and
after assignment of the wireless channels, if an assignment request message is received from the mobile switching center in response to a service request message, transmitting to the mobile switching center an assignment complete message.

10. A mobile station apparatus for performing call setup in a mobile communication system, comprising:
a key input unit for generating a key signal corresponding to a key input by a user;
a radio frequency (RF) unit for up-converting a signal to be transmitted to a base station into an RF signal, and down-converting an RF signal received from the base station into a baseband signal;
a modem for encoding and modulating data or a message to be transmitted to the base station, providing the modulated data or message to the RF unit, and demodulating and decoding the baseband signal received from the RF unit; and
a controller for generating an origination message that does not containing a recipient's phone number and providing the origination message to the modem when a dial signal is received from the key input unit, controlling the RF unit to set up wireless channels and performing service negotiation upon receiving a channel assignment message, and generating an origination continuation message containing the recipient's phone number and providing the origination continuation message to the modem when a key input complete signal is received from the key input unit.

11. The method of claim 10, wherein the origination message included a dummy phone number consisting of all ‘0s’.
